(19) United States
(12) Patent Application Publication
(10) Pub. No.: US 2026/0208414 A1
(43) Pub. Date: Jul. 23, 2026

(54) SPECIFYING DEVICE, MOLDING MACHINE, AND MOLDING SYSTEM

(71) Applicant: SUMITOMO HEAVY INDUSTRIES, LTD., Tokyo (JP)

(72) Inventors: Daigo HOTTA, Chiba-shi (JP); Tomosuke KADOONO, Chiba-shi (JP); Atsuro TAMURA, Chiba-shi (JP)

(21) Appl. No.: 19/299,231

(22) Filed: Aug. 13, 2025

(30) Foreign Application Priority Data
Dec. 18, 2024 (JP) 2024-221826

(51) Int. Cl. B29C 45/17

(52) U.S. Cl. CPC B29C 45/17; B29C 2045/1784; B29C 2945/76434; B29C 2945/76949

(57) ABSTRACT

The present invention relates to a specifying device which includes: an acquisition unit that acquires an operation content of a user with respect to a molding device; and a specifying unit that specifies a skill level of the user in performing work based on the operation content acquired by the acquisition unit.

### CROSS-REFERENCE TO RELATED APPLICATIONS

This application claims priority to Japanese Patent Application No. 2024-221826, filed on Dec. 18, 2024, which is incorporated by reference herein in its entirety.

### BACKGROUND

### Technical Field

A certain embodiment of the present invention relates to a specifying device, a molding machine, and a molding system.

### Description of Related Art

The related art describes a molding machine in which users are grouped according to job roles (administrator, worker, and the like) and only operation authority according to the job roles is granted to each group.

The related art describes an injection molding machine including a touch panel, in which an access level that allows or prohibits display is set for all screens that can be displayed on the touch panel, and display is restricted according to the authority of an operator.

### SUMMARY

According to an embodiment of the present invention, there is provided a specifying device including acquisition means that acquires an operation content of a user with respect to a molding device, and specifying means that specifies a skill level of the user in performing work based on the operation content acquired by the acquisition means.

### BRIEF DESCRIPTION OF THE DRAWINGS

FIG. 1 is a view showing a configuration of an injection molding machine to which the present embodiment is applied.

FIG. 2 is a view showing a configuration of a control device.

FIG. 3 is a view showing a configuration of a data processing device.

FIG. 4 is a view showing a configuration of a skill level specifying device.

FIG. 5 is a view showing a hardware configuration example of a computer that realizes a control device, a data processing device, and a skill level specifying device.

FIGS. 6A and 6B are flowcharts showing an example of a flow of work in a case where a user implements a countermeasure in a case where a defect occurs in the injection molding machine, FIG. 6A shows an example of a flow of work performed by a user having a relatively high skill level of work, and FIG. 6B shows an example of a flow of work performed by a user having a relatively low skill level of work.

FIG. 7 is a diagram showing an example of a table in which a time required for an operation and a skill level of a user in performing work are associated with each other.

FIG. 8 is a diagram showing an example of a decision table for specifying a skill level of a user in performing work based on an operation of the user in a case where a defect occurs.

FIG. 9 is a flowchart showing an example of a flow of processing in a case where a skill level of a user in performing work is specified based on an operation of the user in a case where a defect occurs.

FIG. 10 is a flowchart showing an example of a flow of processing related to providing information to a user.

### DETAILED DESCRIPTION

In the molding machine, information to be provided may be different depending on the role of the user. For example, in a case where there are functions that can be used and functions that cannot be used depending on the role of the user, only information about the functions that can be used may be provided to the user. However, necessary information may be different depending on a skill level of a user in performing the work, for example, regardless of the role of the user. Therefore, for example, it is preferable to specify the skill level of the user in performing the work in order to provide the user with necessary information.

It is desirable to provide a specifying device or the like capable of specifying a skill level of a user in performing work from an operation content of the user.

Hereinafter, an embodiment of the present invention will be described in detail with reference to the accompanying drawings.

### Device Configuration

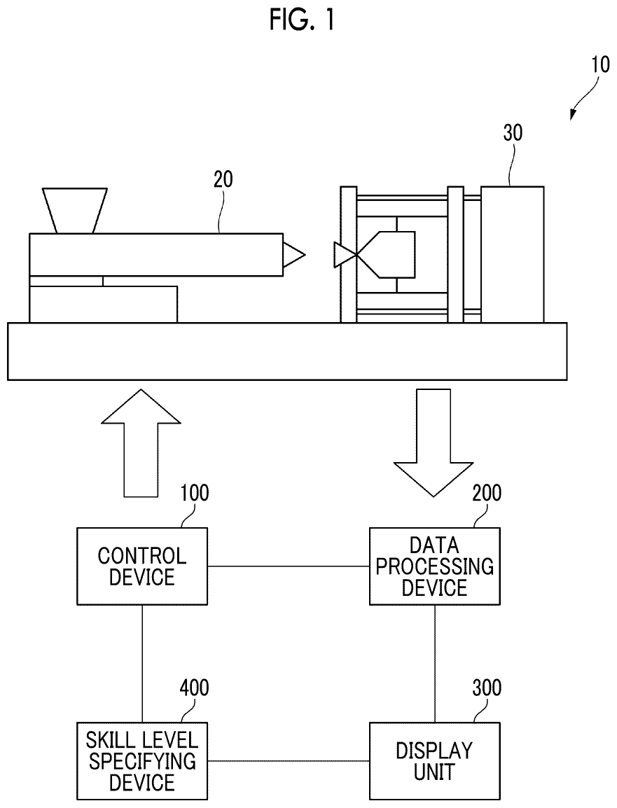

FIG. 1 is a view showing a configuration of an injection molding machine 10 to which the present embodiment is applied. The injection molding machine 10 includes an injection unit 20, a mold clamping unit 30, a control device 100, a data processing device 200, a display unit 300, and a skill level specifying device 400. In the following description, a direction from the injection unit 20 toward the mold clamping unit 30 may be referred to as a front. The injection molding machine 10 is an example of a molding machine. The injection unit 20 and the mold clamping unit 30 are examples of a molding device.

The injection unit 20 is configured with a cylinder that heats a molding material, a screw that is rotatable in the cylinder and that is capable of advancing and retreating in an axial direction, a rotary motor that drives the screw in a rotation direction, a motor that drives the screw in the axial direction, and the like. The molding material is, for example, a resin. The injection unit 20 injects the molding material that is heated and liquefied in the cylinder by advancing the screw in a front direction while rotating the screw, and fills a mold of the mold clamping unit 30 disposed in front of the injection unit 20. The injection unit 20 performs, for example, a plasticizing process, a filling process, a pressure holding process, or the like in a manufacturing process of a molding product. The filling process and the pressure holding process may be collectively referred to as an injection process.

The mold clamping unit 30 includes the mold, a clamping mechanism that clamps the mold, a motor that drives the clamping mechanism, and the like. The mold clamping unit 30 closes the mold to receive the molding material injected from the injection unit 20 into an inside of the mold. In this case, the mold clamping unit 30 clamps the mold by means of a clamping mechanism such that the mold does not open due to the filling of the molding material (mold clamping). A molding product is produced by solidifying the molding material filled in the mold. After that, the mold clamping unit 30 opens the mold and ejects the produced molding product. The mold clamping unit 30 performs, for example, a mold closing process, a pressure increasing process, a mold clamping process, a depressurizing process, a mold opening process, or the like in the manufacturing process of the molding product.

The control device 100 is a device that controls operations of the injection unit 20 and the mold clamping unit 30. The data processing device 200 is a device that processes data obtained as the injection unit 20 and the mold clamping unit 30 operate. The display unit 300 displays information related to the control of the injection unit 20 and the mold clamping unit 30 by the control device 100, data acquired by the data processing device 200, a processing result of the data processing device 200, and the like. In addition, the display unit 300 displays an operation screen for performing an operation to input commands or data to the control device 100 and the data processing device 200. In addition, the display unit 300 displays information of advice provided to a user. The skill level specifying device 400 specifies a skill level of the user in performing the work based on the operation content of the user of the injection molding machine 10.

### Configuration of Control Device 100

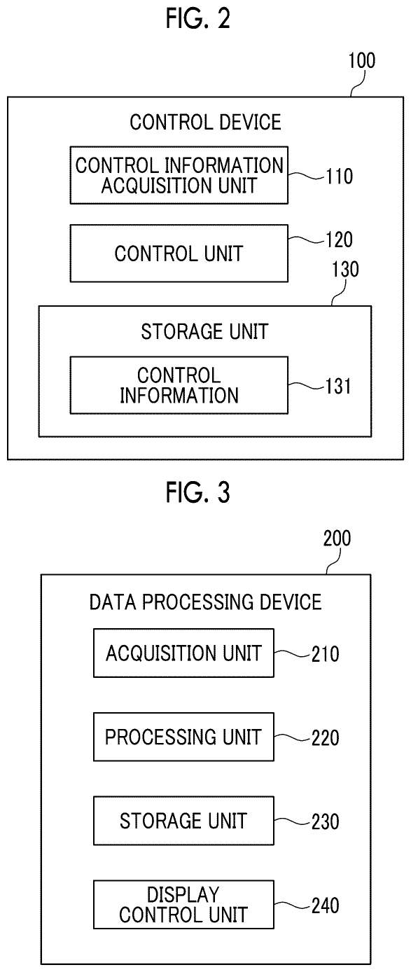

FIG. 2 is a view showing a configuration of the control device 100. The control device 100 controls operations of the injection unit 20 and the mold clamping unit 30. The control device 100 is realized by, for example, a computer. The control device 100 includes a control information acquisition unit 110, a control unit 120, and a storage unit 130. The control device 100 controls the injection unit 20 and the mold clamping unit 30 to repeatedly perform a process related to the manufacturing of the molding product, thereby repeatedly manufacturing the molding product. The process related to the manufacturing of the molding product includes a plasticizing process, a mold closing process, a pressure increasing process, a mold clamping process, a filling process, a pressure holding process, a cooling process, a depressurizing process, a mold opening process, an ejection process, and the like. Hereinafter, these processes related to the manufacturing may be collectively referred to as a “manufacturing process”. In addition, a series of operations for obtaining a molding product, for example, an operation from the start of the plasticizing process in the above manufacturing process to the start of the next plasticizing process is referred to as a “shot”, a “molding cycle”, or the like. In addition, each of the above processes for manufacturing the molding product is merely an example. For example, as a process executed in one shot, another process not included in the above may be included.

The control information acquisition unit 110 acquires control information used to control the injection unit 20 and the mold clamping unit 30. The control information is a condition set by the user, and, for example, is input by the user using an input unit (not shown). For example, the control information includes molding conditions such as a resin temperature, a mold temperature (a cylinder temperature), an injection pressure holding time, a metering value, a V-P switching position, a holding pressure, an injection speed (a filling speed), a screw rotation speed, a screw back pressure, and a mold clamping force. A plurality of combinations of these molding conditions are determined depending on the molding product and the mold. Hereinafter, the combination data of the molding conditions will be also referred to as a molding condition data set. The control information acquisition unit 110 stores the acquired control information in the storage unit 130 as the molding condition data set.

The control unit 120 controls the injection unit 20 and the mold clamping unit 30 by using the above molding condition data set, and performs a process related to the manufacturing (shot) of the molding product including each of the above processes. The control unit 120 reads a molding condition data set corresponding to the molding product to be manufactured from the storage unit 130, for example, in a case where the manufacturing of the molding product starts. Then, the control unit 120 controls the operations of the injection unit 20 and the mold clamping unit 30 based on the read control information. Specifically, the control unit 120 controls the injection unit 20 and the mold clamping unit 30 such that the data obtained from the injection unit 20 and the mold clamping unit 30 in the manufacturing process matches a setting value of the molding condition data set. In addition, the control unit 120 may cause the display unit 300 to display the molding condition data set read from the storage unit 130. The user may refer to the data of the molding conditions displayed on the display unit 300 and may perform an operation such as correcting a value as necessary.

The storage unit 130 holds control information 131 acquired by the control information acquisition unit 110. The molding condition data set included in the control information 131 is prepared in association with a molding product to be manufactured and the mold. The storage unit 130 holds a molding condition data set for each molding product to be manufactured and each mold. In addition, although not shown, the storage unit 130 holds a program for the control unit 120 to control the injection unit 20 and the mold clamping unit 30. As will be described in detail later, the function of the control unit 120 is realized by a processor of the control device 100 reading and executing the program held in the storage unit 130.

### Configuration of Data Processing Device 200

FIG. 3 is a view showing a configuration of the data processing device 200. The data processing device 200 acquires and processes data obtained as the injection unit 20 and the mold clamping unit 30 execute operations in the process related to the manufacturing of the molding product. The data processing device 200 is realized by, for example, a computer. The data processing device 200 includes an acquisition unit 210, a processing unit 220, a storage unit 230, and a display control unit 240.

The acquisition unit 210 acquires data to be processed from the injection unit 20 and the mold clamping unit 30. Various sensors and detectors are attached to the injection unit 20 and the mold clamping unit 30. The data acquired by the sensors and the detectors (hereinafter, referred to as “acquisition data”) is information representing a molding result of the injection unit 20 and the mold clamping unit 30, and is used for quality control of the molding product. Specifically, for example, the weight of the molding product, the dimensions of the molding product, the mold internal pressure, the minimum cushion position, and the feature values of the waveform of the filling pressure are included. The acquisition data is an actual value obtained in a manufacturing process of the molding product. The acquisition unit 210 receives the acquisition data transmitted from the sensor and the detector and stores the acquisition data in the storage unit 230.

The processing unit 220 processes the acquisition data stored in the storage unit 230. Specifically, the processing unit 220 performs processing of extracting a representative value of the acquisition data in each process and processing of generating time series data in which the acquisition data in each process is arranged in chronological order. In extracting the representative value, the processing unit 220 performs statistical processing such as calculating an average value, specifying a range of values, and specifying a maximum value or a minimum value on the acquisition data.

The storage unit 230 holds the representative value, the time series data, the statistical data, and the like, processed by the processing unit 220. The data is associated with, for example, the original acquisition data. Specifically, the data may be stored in a data file of the original acquisition data corresponding to the data. In addition, the data file in which data is stored may be associated with the data file of the original data. Accordingly, each piece of data generated by the processing unit 220 is also held in association with the molding product to be manufactured and the mold in the shot in which the original acquisition data is obtained. As the data format of the data file held in the storage unit 230, for example, comma-separated values (CSV), Extensible Markup Language (XML), JavaScript Object Notation (JSON), or the like can be used.

In addition, although not shown, the storage unit 230 holds a program for the processing unit 220 to execute data processing. As will be described in detail later, the processor of the data processing device 200 reads and executes the program held in the storage unit 230, so that functions of the processing unit 220 are realized.

The display control unit 240 causes the display unit 300 to display the acquisition data and the data of the processing result by the processing unit 220. The data to be displayed includes setting information in the control information used by the control device 100 to control the injection unit 20 and the mold clamping unit 30. The setting information (setting value) can be acquired from the control device 100. The display control unit 240 acquires the data from the storage unit 230 and the storage unit 130 of the control device 100 and causes the data to be displayed on the display unit 300.

### Configuration of Skill Level Specifying Device 400

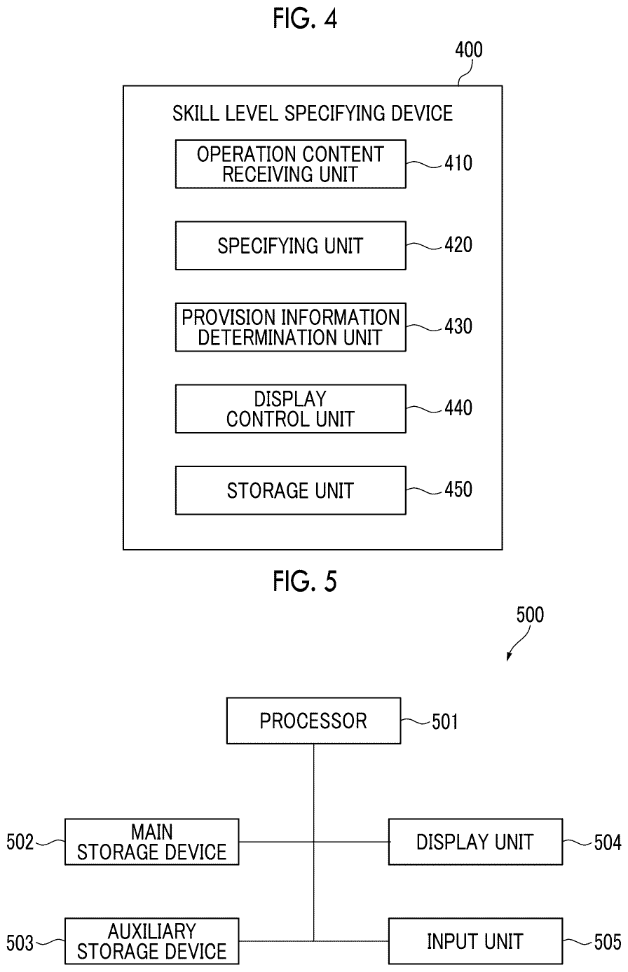

FIG. 4 is a view showing a configuration of the skill level specifying device 400. The skill level specifying device 400 includes an operation content receiving unit 410, a specifying unit 420, a provision information determination unit 430, a display control unit 440, and a storage unit 450.

The operation content receiving unit 410 receives an operation content from the user. The user performs an operation by using an operation screen displayed on the display unit 300, for example. The operation content is the content of the operation performed by the user on the injection molding machine 10, and includes a process, a time, the number of times of execution, a transition screen, an input content, a solution in a case where a problem occurs, and the like related to the operation. The operation content receiving unit 410 is an example of acquisition means.

The specifying unit 420 specifies the skill level of the user in performing the work. The specifying unit 420 specifies the skill level of the user in performing the work, based on the operation content of the user acquired by the operation content receiving unit 410. The skill level of the work is an index indicating the degree of skill and understanding of the user in the work to be performed. The skill level of the user in performing the work specified by the specifying unit 420 is used, for example, as an index for determining information of advice to be provided to the user. A method of specifying the skill level of the user in performing the work by the specifying unit 420 will be described in detail later.

The provision information determination unit 430 determines the information to be provided to the user. The provision information determination unit 430 determines the information to be provided to the user, based on the skill level of the user in performing the work specified by the specifying unit 420. Here, the information to be provided to the user is, for example, information of advice to be provided regarding a function that is available to both a user having a relatively high skill level in the work and a user having a relatively low skill level in the work. The provision information determination unit 430 changes the information of the advice to be provided according to the skill level of the user in performing the work.

The display control unit 440 causes the display unit 300 to display the information of the advice to be provided to the user determined by the provision information determination unit 430. The information of the advice may be displayed on the display unit 300, for example, in a pop-up manner, or the information of the advice may be displayed according to a user's selection. In addition, the information of the advice may be displayed on a display screen other than the display unit 300. For example, the information of the advice may be transmitted to a terminal possessed by the user and may be configured to be displayed on the terminal.

The storage unit 450 stores a specifying criterion for the skill level of the work or the provision information for each skill level of the work.

The specifying criterion for the skill level of the work includes, for example, a time required for a certain operation, the number of times of execution of the operation, a method of dealing with a generated problem, and the like. For example, the storage unit 450 stores a reference time or the number of times of execution for each operation in association with the skill level of the work. The specifying unit 420 determines the skill level of the user in performing the work in comparison with a time required for the user to perform an operation. The specifying criterion may be determined in advance by the user, and the criteria, such as a time, the number of times of execution, and a method of dealing with a generated problem, may be changed by the user.

In addition, the storage unit 450 stores the provision information for each skill level of the work in association with the skill level of the work. The provision information determination unit 430 acquires the provision information according to the specified skill level of the user in performing the work from the storage unit 450 and determines the provision information.

### Hardware Configuration of Computer Realizing Control Device 100, Data Processing Device 200, and Skill Level Specifying Device 400

FIG. 5 is a view showing a hardware configuration example of a computer 500 that realizes the control device 100, the data processing device 200, and the skill level specifying device 400. The computer 500 shown in FIG. 5 includes a processor 501 serving as a calculation means, and a main storage device (main memory) 502 and an auxiliary storage device 503 serving as storage means. As the processor 501, for example, various calculation circuits such as a central processing unit (CPU), a graphics processing unit (GPU), an application-specific integrated circuit (ASIC), and a field-programmable gate array (FPGA) are used. The processor 501 reads a program stored in the auxiliary storage device 503 into the main storage device 502 and executes the program. For example, a random-access memory (RAM) is used as the main storage device 502. For example, a magnetic disk device, a solid-state drive (SSD), or the like is used as the auxiliary storage device 503.

In addition, the computer 500 includes a display unit (display) 504 and an input unit 505 through which a user performs an input operation. For example, a keyboard, a mouse, or the like is used as the input unit 505. Further, a touch panel configured integrally with the display unit 504 may be used as the input unit 505. The display unit 504 may be realized by the display unit 300 shown in FIG. 1. In addition, a configuration of the computer 500 shown in FIG. 5 is merely an example, and the computer 500 used in the present embodiment is not limited to the configuration example of FIG. 5. For example, the configuration may include a non-volatile memory such as a flash memory, or a read-only memory (ROM) may be provided as the storage device.

In a case where the control device 100 is realized by the computer shown in FIG. 5, the control information acquisition unit 110 is realized by, for example, the processor 501 that reads and executes the program and the input unit 505. The function of the control unit 120 is realized, for example, by the processor 501 reading and executing the program. The storage unit 130 is realized by, for example, the auxiliary storage device 503.

In a case where the data processing device 200 is realized by the computer shown in FIG. 5, the functions of the acquisition unit 210 and the processing unit 220 are realized by, for example, the processor 501 reading and executing the program. The storage unit 230 is realized by, for example, the auxiliary storage device 503. The display control unit 240 is realized by the processor 501 that reads and executes the program.

In a case where the skill level specifying device 400 is realized by the computer 500 shown in FIG. 5, the functions of the operation content receiving unit 410, the specifying unit 420, the provision information determination unit 430, and the display control unit 440 are realized, for example, by the processor 501 reading and executing the program. The storage unit 450 is realized by, for example, the auxiliary storage device 503.

### Specifying Skill Level of Work

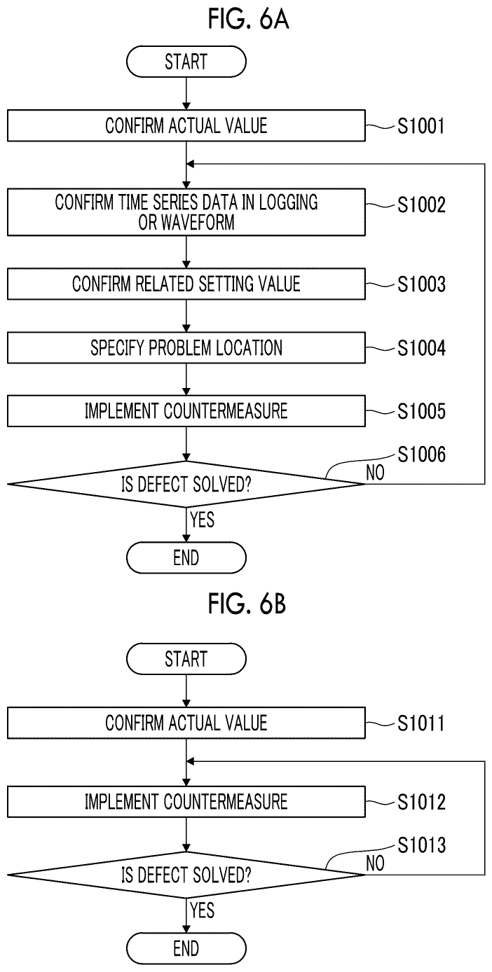

An example of a method of specifying a skill level of the work in the present embodiment will be described with reference to FIGS. 6A to 8.

FIGS. 6A and 6B are flowcharts showing an example of a flow of work in a case where a user implements a countermeasure in a case where a defect occurs in the injection molding machine 10. FIG. 6A shows an example of a flow of work performed by a user having a relatively high skill level of the work, and FIG. 6B shows an example of a flow of work performed by a user having a relatively low skill level of the work.

As shown in FIG. 6A, in a case where a defect occurs, first, the user having a relatively high skill level of the work checks an actual value (Step S1001). The user checks the actual value in one shot in which the defect has occurred. Next, the user checks time series data in a logging or waveform (Step S1002). Next, the user checks a setting value related to the defect that has occurred (Step S1003). Next, the user identifies the problem location based on the information acquired through the checking (Step S1004). Then, the user implements a countermeasure for resolving the defect with respect to the identified problem location (Step S1005). In a case where the defect is resolved (YES in Step S1006), the work is ended. On the other hand, in a case where the defect is not resolved (NO in Step S1006), the user performs the work again from Step S1002. A user having a relatively high skill level in the work tends to identify the problem location by checking the time series data.

On the other hand, a user having a relatively low skill level in the work tends to execute a countermeasure without following a procedure such as checking time series data. The user having a relatively low skill level in the work first checks the actual value in a case where the defect occurs, as shown in FIG. 6B (Step S1011). Then, the user implements a countermeasure for resolving the defect (Step S1012). In a case where the defect is resolved (YES in Step S1013), the work is ended. On the other hand, in a case where the defect is not resolved (NO in Step S1013), the user implements a different countermeasure again.

In this way, since a difference in the skill level of the work is reflected in the operation content, the skill level of the user in performing the work can be specified based on the operation content. For example, the skill level of the user in performing the work is specified according to whether or not the user has accessed a predetermined screen in resolving the defect, or whether or not the user has checked a predetermined setting value.

In addition, the skill level of the user in performing the work may be specified from the time required for the operation.

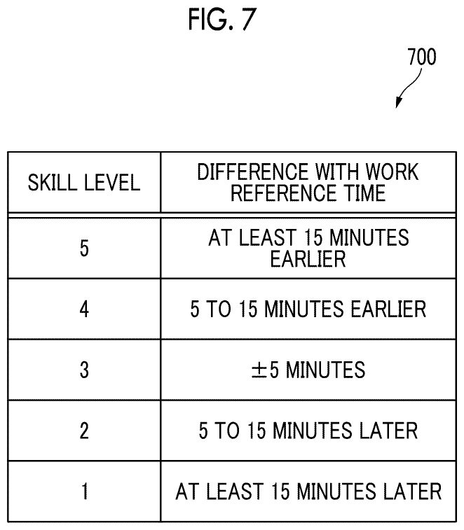

FIG. 7 is a diagram showing an example of a table 700 in which the time required for an operation and a skill level of the user in performing the work are associated with each other. The table 700 is stored in the storage unit 450.

The table 700 is a correspondence table between a difference between a time required for a certain operation and a work reference time, the work reference time being a predetermined reference, and the skill level of the user in performing the work. The table 700 is provided for each operation. In addition, the table 700 may be associated with the time required for the work including a plurality of operations and the skill level of the user in performing the work. In addition, the time required for solving a problem in a case where a problem occurs, the time required to reach the quality standard of the product, and the skill level of the user in performing the work may be associated with each other. The user having a relatively higher skill level in performing the work tends to require a shorter time for the operation.

In the example shown in FIG. 7, for example, the user having a skill level 5 in performing the work completes the work at least 15 minutes earlier than the work reference time. A user having a skill level 4 in performing the work completes the work 5 to 15 minutes earlier than the work reference time. A user having a skill level 3 in performing the work completes the work within ±5 minutes with respect to the work reference time. A user having a skill level 2 in performing the work completes the work 5 to 15 minutes later than the work reference time. A user having a skill level 1 in performing the work completes the work at least 15 minutes later than the work reference time.

The specifying unit 420 specifies the skill level of the user in performing the work in comparison with the operation time of the user with the table 700. For example, in a case where the user performs the work with a work reference time of 30 minutes in 40 minutes, the specifying unit 420 specifies the skill level of the user in performing the work as “2”.

In addition, the skill level of the user in performing the work may be specified from the number of times a specific operation is repeatedly executed. In this case, a table in which the number of times of execution of the operation and the skill level of the user in performing the work are associated with each other is stored in the storage unit 450. The table stored in the storage unit 450 is, for example, a correspondence table between a difference between the number of times a certain operation is performed and a predetermined reference number of times of the operation and the skill level of the user in performing the work. The user having a relatively lower skill level in performing the work tends to repeatedly perform the same operation.

The specifying unit 420 specifies the skill level of the user in performing the work in comparison with the number of times of execution of the operation performed by the user with the table stored in the storage unit 450.

In addition, in a case where a problem occurs, the skill level of the user in performing the work may be specified from the amount of information acquired by the user before the user implements a countermeasure against the problem. The user having a relatively higher skill level in performing the work tends to acquire information by checking a greater number of screens and setting values before implementing the countermeasure against the problem. As the amount of information acquired by the user, for example, the number of times of screen transitions performed by the user can be given.

In this case, a table in which the number of screen transitions and the skill level of the user in performing the work are associated with each other is stored in the storage unit 450. The number of screen transitions may be the number of transitions for all screens or the number of transitions to a predetermined specific screen.

In addition, the skill level of the user in performing the work may be specified based on whether or not the user accesses a predetermined screen before implementing a countermeasure against a problem in a case where the problem occurs. For each problem that occurs, there is a screen or a setting value that is often checked by a user having a relatively high skill level in performing the work. In this case, a table in which whether or not the user accesses a certain screen and the skill level of the user in performing the work are associated with each other is stored in the storage unit 450. The table is, for example, a decision table for specifying the skill level of the user in performing the work based on whether or not a plurality of screens are accessed.

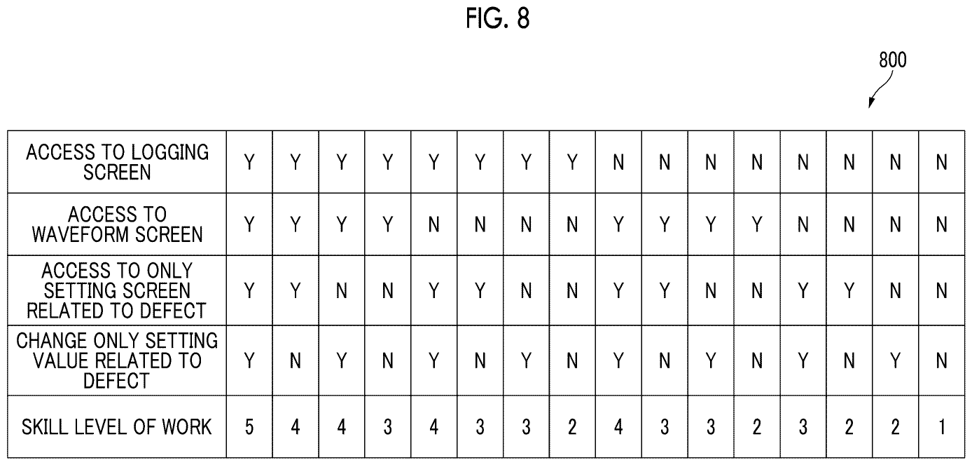

For example, a method of specifying the skill level of the user in performing the work based on the operation of the user in a case where a defect occurs will be described using a decision table 800 shown in FIG. 8.

FIG. 8 is a diagram showing an example of the decision table 800 for specifying the skill level of the user in performing the work based on an operation of the user in a case where a defect occurs. The decision table 800 is stored in the storage unit 450.

The decision table 800 is a correspondence table between whether or not a user has performed a specific operation in a case where a defect has occurred and the skill level of the user in performing the work. In the example shown in FIG. 8, the skill level of the user in performing the work is specified based on whether or not the user performs “access to a logging screen”, “access to a waveform screen”, “access to only a setting screen related to the defect”, and “change to only the setting value related to the defect”.

In the decision table 800, “Y” indicates that the operation is executed, and “N” indicates that the operation is not executed.

In a case where “Y” is set in the “access to a logging screen”, it indicates that the user has accessed the logging screen, and in a case where “N” is set, it indicates that the user has not accessed the logging screen. In a case where “Y” is set in the “access to a waveform screen”, it indicates that the user has accessed the waveform screen, and in a case where “N” is set, it indicates that the user has not accessed the waveform screen. The user having a relatively higher skill level in performing the work tends to acquire information by accessing the logging screen and the waveform screen before implementing the countermeasure against the defect.

In a case where “Y” is set in “access to only a setting screen related to the defect”, it indicates that the user has accessed only the setting screen related to the defect, and in a case where “N” is set, it indicates that the user has accessed the setting screen not related to the defect. In a case where “Y” is set in “change to only the setting value related to the defect”, it indicates that the user has changed only the setting value related to the defect, and in a case where “N” is set, it indicates that the user has also changed the setting value not related to the defect.

Whether or not each screen is a setting screen related to the defect is determined in advance for each defect, and is stored in the storage unit 450. In addition, whether or not each setting value is a setting value related to the defect is, for example, determined in advance for each defect, and is stored in the storage unit 450. The user having a relatively lower skill level in performing the work tends to access the setting screen not related to the defect or change the setting value not related to the defect.

The specifying unit 420 specifies the skill level of the user in performing the work in comparison with the user's operation in a case where a defect occurs with the decision table 800. For example, it is assumed that a defect occurs, and the user accesses the logging screen (Y), and accesses the waveform screen (Y). In addition, it is assumed that the user accesses a setting screen not related to the defect (N) and changes a setting value not related to the defect (N). In this case, the specifying unit 420 specifies the skill level of the user in performing the work as “3” from the decision table 800.

In this way, for example, the skill level of the user in performing the work can be specified from the operation of the user in a case where a problem occurs in the present embodiment by using the decision table 800 shown in FIG. 8. By specifying the skill level of the user in performing the work based on the type of information acquired by the user and the type of operation performed by the user, such as the screen access and the setting value change, the accuracy of specifying the skill level of the work can be improved.

### Flow of Information Provision Processing

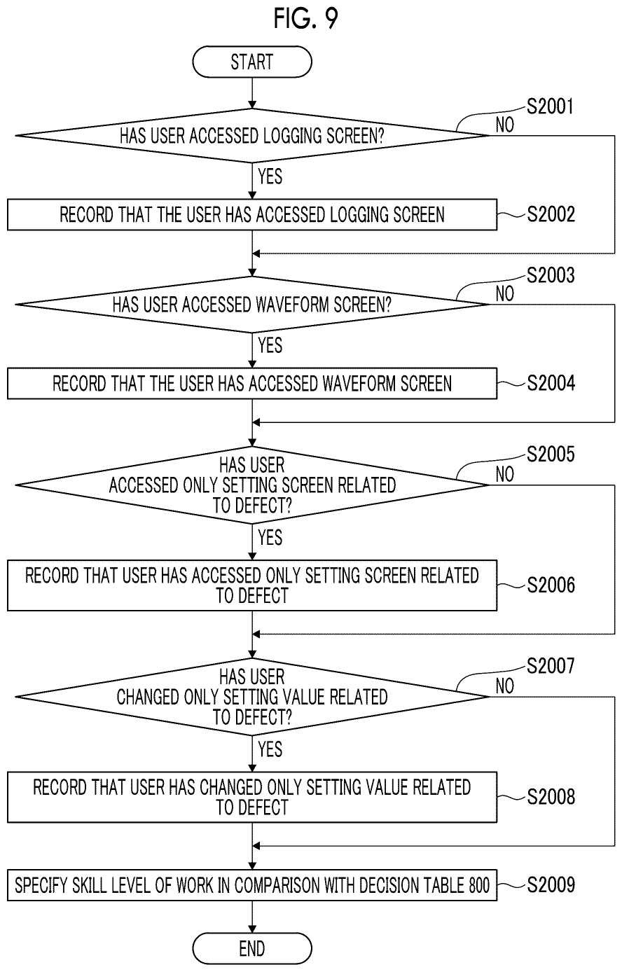

FIG. 9 is a flowchart showing an example of a flow of processing in a case where a skill level of a user in performing work is specified based on an operation of the user in a case where a defect occurs. Here, a flow of processing in a case where the skill level of the work is specified by using the decision table 800 shown in FIG. 8 will be described.

In FIG. 9, first, the specifying unit 420 determines whether or not the user has accessed the logging screen (Step S2001). In a case where the user has accessed the logging screen (YES in Step S2001), the specifying unit 420 records that the user has accessed the logging screen (Step S2002). On the other hand, in a case where the user has not accessed the logging screen (NO in Step S2001), the processing proceeds to Step S2003.

Next, the specifying unit 420 determines whether or not the user has accessed a waveform screen (Step S2003). In a case where the user has accessed the waveform screen (YES in Step S2003), the specifying unit 420 records that the user has accessed the waveform screen (Step S2004). On the other hand, in a case where the user has not accessed the waveform screen (NO in Step S2003), the processing proceeds to Step S2005.

Next, the specifying unit 420 determines whether or not the user has accessed only a setting screen related to the defect (Step S2005). In a case where the user has accessed only the setting screen related to the defect (YES in Step S2005), the specifying unit 420 records that the user has accessed only the setting screen related to the defect (Step S2006). On the other hand, in a case where the user has accessed a setting screen that is not related to the defect (NO in Step S2005), the processing proceeds to Step S2007.

Next, the specifying unit 420 determines whether or not the user has changed only the setting value related to the defect (Step S2007). In a case where the user has changed only the setting value related to the defect (YES in Step S2007), the specifying unit 420 records that the user has changed only the setting value related to the defect (Step S2008). On the other hand, in a case where the user has changed the setting value that is not related to the defect (NO in Step S2007), the processing proceeds to Step S2009.

Then, the specifying unit 420 specifies the skill level of the work in comparison with the decision table 800 (Step S2009). In Steps 2001, 2003, 2005, and 2007, in a case of YES, the specifying unit records “Y”. Then, the recorded “Y” is compared with the decision table 800 to specify the skill level of the user in performing the work.

The method of specifying the skill level of the work described above is an example, and the present invention is not limited thereto. For example, the specifying criterion used when the specifying means specifies the skill level of the work may be changed by the user. In addition, the flow of the processing shown in FIG. 9 is an example, and an order of the processing is not limited thereto. For example, the processing shown in Steps 2001, 2003, 2005, and 2007 may be executed in a different order.

### Flow of Information Provision Processing

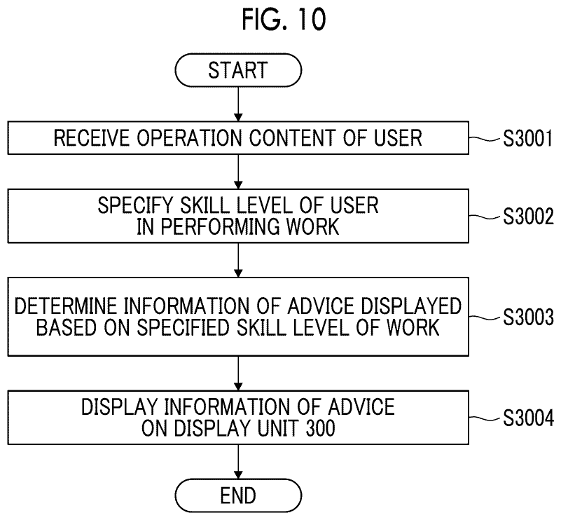

FIG. 10 is a flowchart showing an example of a flow of processing related to providing information to a user.

In FIG. 10, first, the operation content receiving unit 410 receives the operation content from the user (Step S3001). Next, the specifying unit 420 specifies the skill level of the user in performing the work (Step S3002). The specifying unit 420 specifies the skill level of the user in performing the work, for example, in accordance with the flowchart shown in FIG. 9.

Next, the provision information determination unit 430 determines the information of the advice to be displayed, based on the specified skill level of the work (Step S3003). The provision information determination unit 430 determines the information stored in the storage unit 450 as the provision information in association with the specified skill level of the work. Then, the display control unit 440 causes the display unit 300 to display the information of the advice (Step S3004).

In addition, the specified skill level of the work in the present embodiment is used as an index for determining the information to be provided to the user, but is not limited thereto. The skill level of the work may be used for other purposes.

Although the embodiment of the present invention has been described above, the technical scope of the present invention is not limited to the above embodiment. For example, the information stored in the storage unit 450 may be managed in an external server connected to the skill level specifying device 400 to be communicable with each other. The server may be a so-called local server, or may be a virtual server (for example, a cloud server) constructed using resources on a network, or the like. In addition, for example, the skill level of the user in performing the work may be specified by a relative evaluation in a group to which the user belongs, instead of an absolute evaluation using a numerical value. For example, all the members of the group may perform the reference operation, and the skill level of the work may be specified from the content of the operation.

In addition, the processing executed by the skill level specifying device 400 may be executed by an external device such as a smartphone, a PC, or a server. Each functional configuration shown in FIG. 4 may be provided in an external device, and each function may also be distributed and executed across a plurality of devices, servers, or the like. In a case where each function is distributed and executed by the plurality of devices, servers, or the like, any device may execute any processing.

In a case where each function is distributed and executed by the plurality of devices, for example, the injection molding machine 10 acquires the operation content of the user and transmits the acquired operation content to an external server or the like. The server receives the operation content and specifies the skill level of the user in performing the work from the operation content. In this case, the injection molding machine 10 can be regarded as an example of acquisition means that acquires the operation content of the user. In addition, the server is an example of acquisition means that acquires the operation content of the user, and can be regarded as an example of specifying means that specifies the skill level of the user in performing the work.

In addition, it is clear from the description of the claims that combinations of two or more of the above embodiments, as well as various changes or improvements made to the above embodiments, are also included in the technical scope of the present disclosure.

It should be understood that the invention is not limited to the above-described embodiment, but may be modified into various forms on the basis of the spirit of the invention. Additionally, the modifications are included in the scope of the invention.

What is claimed is:

1. A specifying device comprising:
an acquisition unit that acquires an operation content of a user with respect to a molding device; and
a specifying unit that specifies a skill level of the user in performing work based on the operation content acquired by the acquisition unit.

2. The specifying device according to claim 1, comprising:
an operation content receiving unit that receives the operation content from the user, as the acquisition unit.

3. The specifying device according to claim 2, further comprising:
a provision information determination unit that determines information to be provided to the user;
a display control unit that causes a display unit to display the information to be provided to the user; and
a storage unit that stores a specifying criterion for the skill level of the work or provision information for each skill level of the work.

4. The specifying device according to claim 3,
wherein the provision information determination unit determines the information to be provided to the user based on the skill level of the user in performing the work specified by the specifying unit.

5. The specifying device according to claim 4,
wherein the provision information determination unit determines information stored in the storage unit as the provision information in association with the skill level of the work that is specified.

6. The specifying device according to claim 3,
wherein the storage unit stores a reference time or the number of times of execution for each operation in association with the skill level of the work.

7. The specifying device according to claim 1,
wherein the skill level of the work specified by the specifying unit is used as an index for determining information of advice to be provided to the user.

8. The specifying device according to claim 1,
wherein the specifying unit specifies the skill level of the user in performing the work based on a time required for a predetermined operation.

9. The specifying device according to claim 1,
wherein the specifying unit specifies the skill level of the user in performing the work based on the number of times of execution of a predetermined operation.

10. The specifying device according to claim 1,
wherein the specifying unit specifies the skill level of the user in performing the work, based on an amount of information acquired by the user before implementing a countermeasure against a problem in a case where the problem occurs.

11. The specifying device according to claim 10,
wherein the specifying unit specifies the skill level of the user in performing the work, based on the number of screen transitions performed by the user before implementing the countermeasure against the problem.

12. The specifying device according to claim 1,
wherein the specifying unit specifies the skill level of the user in performing the work, based on whether or not the user accesses a predetermined screen before implementing a countermeasure against a problem in a case where the problem occurs.

13. The specifying device according to claim 1,
wherein the specifying unit specifies the skill level of the user in performing the work by comparing the operation content acquired by the acquisition unit with a specifying criterion predetermined by the user.

14. A molding machine comprising:
the specifying device according to claim 1; and
the molding device.

15. A molding system comprising:
an acquisition unit that acquires an operation content of a user with respect to a molding device; and
a specifying unit that specifies a skill level of the user in performing work based on the operation content acquired by the acquisition unit.
